(19) United States
(12) Patent Application Publication
(10) Pub. No.: US 2004/0239488 A1
(43) Pub. Date: Dec. 2, 2004

(54) Disabling vehicle with in-vehicle telematics unit

(75) Inventors: William A. Douglass JR., Troy, MI (US); Christopher L. Oesterling, Troy, MI (US)

Correspondence Address: General Motors Corporation, Legal Staff, Mail Code 482-C23-B21, 300 Renaissance Center, P.O. Box 300, Detroit, MI, 48265-3000, US

(73) Assignee: General Motors Corporation

(21) Appl. No.: 10/452,335

(22) Filed: Jun. 2, 2003

(51) Int. Cl. B60R 25/10

(52) U.S. Cl. 340/426.11; 307/10.3

(57) ABSTRACT

The present invention provides a system and method for disabling a mobile vehicle. A data signal for disabling the vehicle is received at an in-vehicle telematics unit, which monitors for a trigger event in response to the receipt of the data signal. A disable command is sent from the telematics unit to a vehicle control module when the trigger event is detected. A computer usable medium with suitable computer program code is employed to disable a mobile vehicle.

### FIELD OF THE INVENTION

This invention relates generally to telematics units for mobile vehicles. In particular the invention relates to a system and method for disabling a mobile vehicle having an in-vehicle telematics unit.

### BACKGROUND OF THE INVENTION

One of the fastest growing areas of communications technology is related to automobile network solutions. The demands and potential for wireless vehicle communication, networking and diagnostic services have escalated in recent years, with projections that by 2006 almost all new American cars will have some level of telematics service. Although many vehicles on the road today have limited wireless communication functions, such as unlocking a door and setting or disabling a car alarm, new vehicles offer additional wireless communication systems that help personalize comfort settings, run maintenance and diagnostic functions, place telephone calls, access call-center information, update controller systems, determine vehicle location, assist in tracking vehicle after a theft of the vehicle and provide other vehicle-related services. Drivers can call telematics call centers to receive navigational, concierge, emergency, and location services, as well as other specialized help such as locating the geographical position of a vehicle when it has been stolen and honking the horn of a vehicle when it cannot be located in a large parking garage.

When a vehicle is stolen, the owner can initiate vehicle tracking by contacting a call center and notifying the call center of the theft. Once a vehicle is located, local law enforcement is dispatched to the vehicle's location. If a vehicle is moving it is advantageous to wait until the vehicle is parked before retrieving the vehicle to prevent a high-speed chase or other dangerous situation. The vehicle may move before law enforcement has the opportunity to reach the vehicle's location. The call center can send a data signal to immediately disable the vehicle, thereby, preventing the vehicle from being moved. If an immediate disable data signal is sent while a vehicle is traveling, at a high rate of speed or on a geometrically complex road, unpredictable vehicle handling may result. It is desirable, therefore, to provide a system and, method for disabling a vehicle, that overcomes the challenges and obstacles described above.

### SUMMARY OF THE INVENTION

One aspect of the invention provides a method for disabling a mobile vehicle. A data signal for disabling the vehicle is received at an in-vehicle telematics unit. The method then monitors for a trigger event in response to the receipt of the data signal. A disable command is sent from the telematics unit to a vehicle control module when the trigger event is detected.

Another aspect of the invention provides a computer usable medium including a program for disabling a mobile vehicle. The computer usable medium comprises computer program code to receive a data signal for disabling the vehicle at an in-vehicle telematics unit and computer program code to monitor for a trigger event in response to the receipt of the data signal. The computer usable medium also comprising, computer program code to send a disable command from the telematics unit to a vehicle control module when the trigger event is detected.

Another aspect of the invention provides a system for disabling a mobile vehicle. The system comprises means for receiving a data signal for disabling the vehicle at an in-vehicle telematics unit and means for monitoring for a trigger event in response to the receipt of the data signal. The system also comprising means for sending a disable command from the telematics unit to a vehicle control module when the trigger event is detected.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic of one embodiment of a system for disabling a mobile vehicle in accordance with the invention.

FIG. 2 is a flow diagram outlining one embodiment of a method for disabling a mobile vehicle in accordance with the invention.

FIG. 3 is schematic of the telematics unit of one embodiment of a system for disabling a mobile vehicle.

### DETAILED DESCRIPTION OF THE PRESENTLY PREFERRED EMBODIMENTS

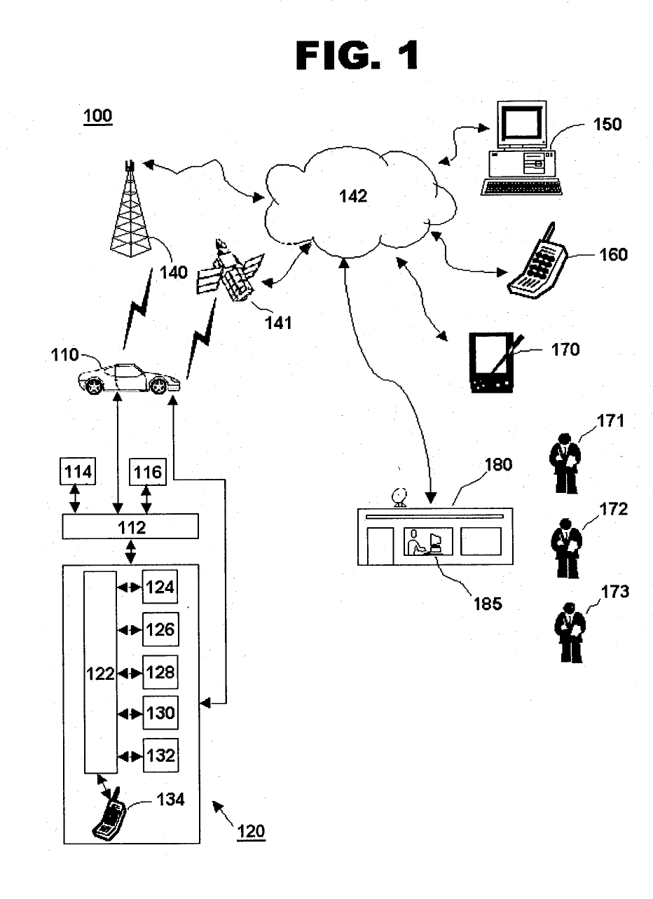

FIG. 1 is a schematic of one embodiment of a system for disabling a mobile vehicle in accordance with the invention at 100. Mobile vehicle disabling system 100 includes a mobile vehicle 110, a telematics unit 120, one or more wireless carrier systems 140 or satellite carrier systems 141, one or more communication networks 142, and one or more call centers 180. Mobile vehicle 110 may be a vehicle such as a car or truck equipped with suitable hardware and software for transmitting and receiving voice and data communications.

Telematics unit 120 may include a digital signal processor (DSP) 122 connected to a wireless modem 124, a global positioning system (GPS) receiver or GPS unit 126, an in-vehicle memory 128, a microphone 130, one or more speakers 132, and an embedded or in-vehicle phone 134. DSP 122 may also be referred to as a microcontroller, microcomputer, controller, host processor, or vehicle communications processor. GPS unit 126 may provide longitude and latitude coordinates of the vehicle. In-vehicle phone 134 may be an analog, digital, dual-mode, dual-band, multi-mode or multi-band cellular phone.

Telematics unit 120 can store vehicle data upload (VDU) records numbers in in-vehicle memory 128. Telematics unit 120 can set or reset calling-state indicators and can enable or disable various cellular-phone and telematics-unit functions when directed by computer instructions running on DSP 122. Telematics unit 120 can send and receive over-the-air messages using, for example, a pseudo-standard air-interface function or other proprietary and non-proprietary communication links.

DSP 122 executes various computer programs and computer program code that control programming and operational modes of electronic and mechanical systems within telematics unit 120. DSP 122 may control communications between telematics unit 120, wireless carrier system 140 or satellite carrier system 141 and call center 180. A voice-recognition application may be installed in DSP 122 that can translate human voice input through microphone 130 to digital signals. For example, programming of in-vehicle phone 134 may be controlled with verbal commands that are translated by voice-recognition software executed by DSP 122. Alternatively, pushing buttons on an interface of telematics unit 120 or in-vehicle phone 134 may be used to change a phone number and other phone configuration settings. The interface to telematics unit 120 may include one or more buttons on the telematics unit, radio console, or associated keyboard or keypad. The interface to telematics unit 120 may include other forms of preference and data entry including touch-screens, wired or wireless keypad remotes, or other wirelessly connected devices such as Bluetooth-enabled devices or 802.11-enabled devices, such as 802.11(a), 802.11 (b) or 802.11 (g) devices.

DSP 122 controls, generates and accepts digital signals transmitted between telematics unit 120 and a vehicle communication bus 112 that is connected to various electronic modules 114 and sensors 116 in mobile vehicle 110. DSP 122 may activate various programming and operation modes, as well as provide for data transfers. Signals from DSP 122 may be translated into voice messages and sent out through speaker 132. One of the generated voice messages may include a phone number prompt given when a user has requested and entered a programming mode of in-vehicle phone 134.

Mobile vehicle 110 via telematics unit 120 may send and receive radio transmissions from wireless carrier system 140, or satellite carrier system 141. Wireless carrier system 140, or satellite carrier system 141 may be any suitable system for transmitting a signal from mobile vehicle 110 to communication network 142.

Communication network 142 includes services from mobile telephone switching offices, wireless networks, public-switched telephone networks, and Internet protocol (IP) networks. Communication network 142 may be comprised of a wired network, an optical network, a fiber network, another wireless network, or any combination thereof. Communication network 142 connects to mobile vehicle 110 via wireless carrier system 140. Communication network 142 may connect wireless carrier system 140 to user computer 150, cellular phone 160, handheld device, such as personal digital assistant 170, and call center 180. Communication network 142 may send and receive short messages according to established protocols such as IS-637 standards for short message service (SMS), IS-136 air-interface standards for SMS, and GSM 03.40 and 09.02 standards. Similar to paging, an SMS communication may be posted along with an intended recipient, such as a communication device in mobile vehicle 110.

Call center 180 may be a location where many calls may be received and serviced at the same time, or where many calls may be sent at the same time. The call center may be a telematics call center, prescribing communications to and from telematics unit 120 in mobile vehicle 110. The call center 180 may be a voice call center, providing verbal communications between an advisor 185 in the call center 180 and a subscriber. The call center 180 may contain each of these functions. Call center 180 may receive a telematics unit access request from a telematics user via wireless carrier system 140, or communication network 150. Call center 180 provides services to telematics unit 120. Communication services advisor 185 provides the disable engine service as one of a number of services available to a subscriber. Call center 180 may transmit data via data signal, such as a vehicle data upload (VDU), to telematics unit 120 in mobile vehicle 110 through wireless carrier system 140, satellite carrier systems 141, or communication network 142.

Communication services advisor 185 may be a real advisor or a virtual advisor. A real advisor is a human being in verbal communication with a user or subscriber. A virtual advisor may be a synthesized voice interface responding to requests from telematics unit 120 in mobile vehicle 110. This virtual advisor may include one or more recorded messages.

Call center 180 can determine mobile identification numbers and telematics unit identifiers associated with a telematics unit access request, compare mobile identification numbers and telematics unit identifiers with a database of identifier records, and send calling-state messages to the telematics unit 120 based on the request and identification numbers.

In alternative embodiments, mobile vehicle manufacturer 171, mobile vehicle dealer 172, or mobile vehicle owner 173 may have user computer 150 or handheld device 170. Local provisioning system such as user computer 150 or handheld device 170 may have a wireless modem to send data through a wireless carrier system 140, which connects to communication network 142. Data is received at call center 180. Call Center 180 may have any suitable hardware and software capable of providing web services to help transmit messages and data signals from local provisioning system, such as, user computer 150 or handheld device 170 to telematics unit 120 in mobile vehicle 110. User computer 150 or handheld device 170 may also have suitable hardware and software to connect to mobile vehicle 110 using a direct link to a mobile vehicle onboard data port.

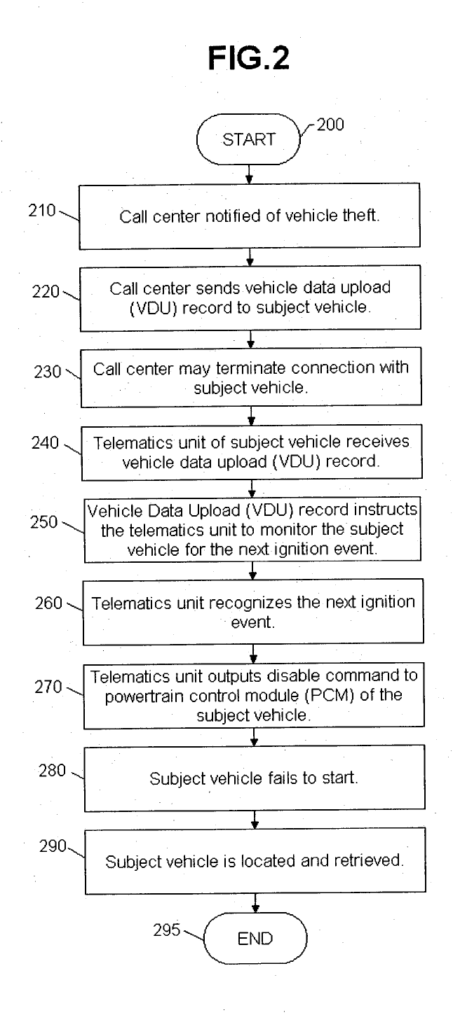

FIG. 2 is a flow chart of one embodiment of a method for disabling a mobile vehicle made in accordance with the invention. The mobile vehicle disabling method begins 200 when a vehicle is reported as stolen or missing and a call center is notified of the vehicle theft 210. The call center sends a data signal, in this case, a vehicle data upload (VDU) record to the telematics unit of the subject vehicle 220. Once the vehicle data upload record is sent by the call center no further communication between the call center and the vehicle is necessary 230. The telematics unit of the subject vehicle receives the vehicle data upload record 240. The vehicle data upload record instructs the telematics unit to begin monitoring for a vehicle ignition event 250. Each time the vehicle engine is started or a start attempt is made, an ignition event occurs. If the vehicle is in operation at the time the data upload it will continue to operate normally. The telematics unit will recognize the next ignition event 260. Upon recognition of the ignition event the telematics unit will output a disable engine command to the vehicle control module such as a powertrain control module (PCM) 270 and the engine will fail to start 280. Once the vehicle is disabled, it is located and retrieved 290 and the method ends 295. The method may be referred to as a virtual kill switch.

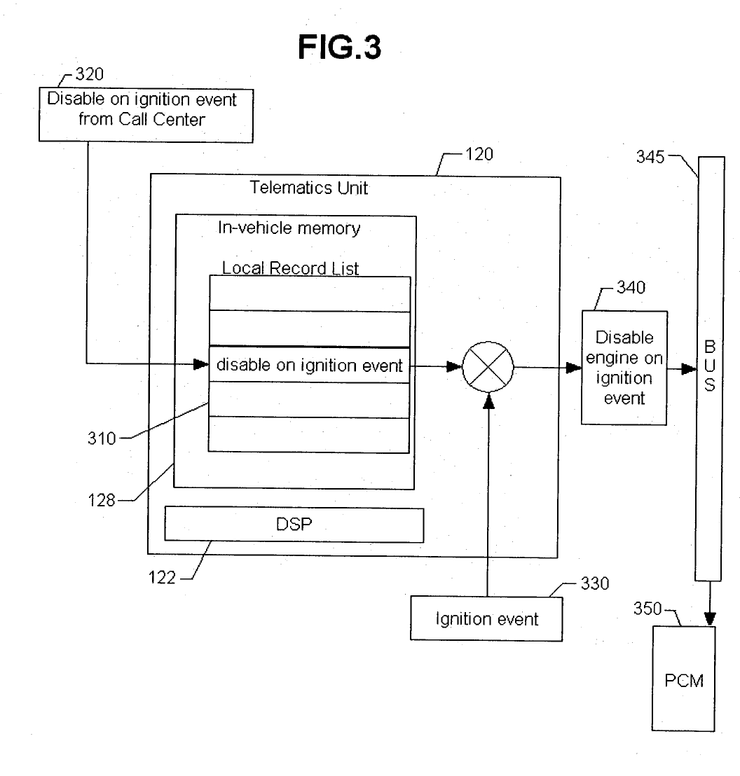

FIG. 3 is schematic of the telematics unit 120 of one embodiment of a system for disabling a mobile vehicle. Telematics unit contains local record list 310 that is a portion of in-vehicle memory 128. When the disable on ignition event trigger is sent from the call center 320, it is received by telematics unit 120 and placed on the local record list 310 location of the in-vehicle memory 128. The local record list is periodically scanned by the DSP 122. If disable on ignition event trigger is resident in local record list 310 and ignition event 330 is detected, telematics unit will output disable engine command 340 to the vehicle control module such as a powertrain control module (PCM) 350 over vehicle bus 345. The disable engine command may be a discrete signal or, in most cases, a bus message. Other trigger events are managed in the same manner.

In alternative embodiments, besides sending the vehicle data upload record from a call center in response to theft of the vehicle, other means may be used to activate the mobile vehicle disable method. An electronic module of the vehicle may initiate sending the vehicle data upload record containing the disable vehicle trigger event to the telematics unit. A scheduled or periodic programming event of the telematics unit itself may also initiate vehicle data upload record containing the disable vehicle trigger event. A manufacturer, at time of vehicle manufacture, may send a vehicle data upload record to the telematics unit. An automobile dealer may also send a vehicle data upload record to the telematics unit while the vehicle is at the dealer's lot. In addition, after purchase of the vehicle, the vehicle's owner can send a vehicle data upload record to the telematics unit. A local provisioning system such as: personal computer, personal digital assistant or other communication device, properly enabled, may be used in these circumstances to initiate the upload. The manufacturer, dealer, or owner can disable the vehicle upon any of a variety of trigger events, such as the vehicle odometer exceeding a pre-established mileage limit, the vehicle traveling farther than a pre-established distance, the vehicle's location changing, the vehicle receiving an improper access code, or a change in an operational parameter of the vehicle, among others. Operational parameters may include engine RPM, engine temperature, engine oil pressure, or engine emission levels among others.

While embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for disabling a mobile vehicle comprising:
receiving a data signal for disabling the vehicle at an in-vehicle telematics unit;
monitoring for a trigger event in response to the receipt of the data signal; and
sending a disable command from the telematics unit to a vehicle control module when the trigger event is detected.

2. The method of claim 1 wherein the data signal for disabling the vehicle is sent from a call center.

3. The method of claim 1 wherein the disable command is a disable engine command.

4. The method of claim 1 wherein the disable command is a discrete signal.

5. The method of claim 1 wherein the disable command is a vehicle bus message.

6. The method of claim 1 wherein the trigger event is selected from the group consisting of a mobile vehicle ignition event, a mobile vehicle operational parameter change, a predetermined mileage limit, a predetermined time limit, a predetermined travel distance, an improper access code entry, or a mobile vehicle location change.

7. The method of claim 1 wherein the data signal for disabling the mobile vehicle comprises a vehicle data upload (VDU) record.

8. The method of claim 1 wherein the control module comprises a powertrain control module (PCM).

9. The method of claim 1 wherein the data signal for disabling the mobile vehicle is sent over a wireless carrier system.

10. The method of claim 1 wherein the data signal for disabling the mobile vehicle is sent over a satellite carrier system.

11. The method of claim 1 wherein the data signal for disabling the vehicle is sent from a local provisioning system.

12. A computer usable medium including a program for disabling a mobile vehicle comprising:
computer program code to receive a data signal for disabling the vehicle at an in-vehicle telematics unit;
computer program code to monitor for a trigger event in response to the receipt of the data signal; and
computer program code to send a disable command from the telematics unit to a vehicle control module when the trigger event is detected.

13. The computer usable medium of claim 12 further comprising:
computer program code to send the data signal for disabling the vehicle from a call center.

14. The computer usable medium of claim 12 further comprising:
computer program code to send data signal for disabling the vehicle from a local provisioning system.

15. A system for disabling a mobile vehicle comprising:
means for receiving a data signal for disabling the vehicle at an in-vehicle telematics unit;
means for monitoring for a trigger event in response to the receipt of the data signal; and
means for sending a disable command from the telematics unit to a vehicle control module when the trigger event is detected.

16. The system of claim 15 further comprising:
means for sending the data signal for disabling the vehicle from a call center.

17. The system of claim 15 further comprising:
means for sending the data signal for disabling the vehicle from a local provisioning system.
